(19) United States
(12) Patent Application Publication
(10) Pub. No.: US 2009/0179115 A1
(43) Pub. Date: Jul. 16, 2009

(54) Retaining ring structure for fixing a satellite antenna

(76) Inventor: Wen-Chao Shen, Bade City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/007,397

(22) Filed: Jan. 10, 2008

(51) Int. Cl. F16L 3/08

(52) U.S. Cl. 248/65

(57) ABSTRACT

A retaining ring structure for fixing a satellite antenna having a retaining ring integrally formed by stamping a metal piece. The retaining ring consists of a C-shaped body and two clamping pieces extending from a slot of the C-shaped body to the outside. A plurality of projecting pieces is axially formed by a stamping process from the external side toward the internal side such that the C-shaped body is properly contracted to grip the positioning rod when the clamping pieces are tightened with bolts. Meanwhile, the projecting pieces create a biting structure that bites the positioning rod such that the positioning rod is firmly held by the retaining ring to prevent the retaining ring from rotation on the positioning rod. Moreover, the structure in accordance with the invention can withstand the inertia toque created by the strong wind force acting on the receiving dished plate. Meanwhile, the receiving dished plate won't be rotated so that an accurate direction of the receiving dished plate as well as an improved quality of receiving the satellite signals can be ensured.

### BACKGROUND OF THE INVENTION

1. Field of the Invention

The invention relates to a retaining ring structure for fixing a satellite antenna, and more particularly to a retaining ring that is integrally made by metal. Moreover, the internal side of the retaining ring includes projecting pieces for biting the positioning rod. In this way, a biting structure is created to prevent the retaining ring from rotation on the positioning rod.

2. Description of the Related Art

In the past, wireless communications on ground are usually affected by factors such as landforms and constructions, atmospheric layer, curvature of the earth, and electromagnetic field of the space, so that normal radio waves of communications are reflected, refracted and diffracted to give rise to poor communication effect and quality.

Thereafter, a communication satellite is introduced to overcome the shortcomings of traditional wireless communications, and an earth station including a dish antenna, a feedhorn, a low noise amplifier (LNA), a down converter, and a satellite is a major electronic means for receiving satellite signals, and thus radio wave signals transmitted by a satellite in a space orbit can be received effectively.

A dish antenna is a window for the whole earth station and its appearance looks like a dish, but its structure is actually in a parabolic shape for facilitating the focus of weak signals dispersed on the surface of the antenna, so that the front side of the antenna becomes a single focal point. Such focal point is usually used as a position for installing a feedhorn. The dish antenna must be accurately aligned to the receiving direction for capturing signals from a satellite in the space. As a result, the dish antenna must be stably positioned to avoid that the satellite signals are not received due to the deviation of angle.

As shown in FIGS. 1A and 1B, a receiving dished plate 10 of a satellite antenna has a back 11 that is pivotally attached to a projecting ear 21 at the front end of a ┌-shaped connecting unit 20. Thereafter, the receiving dished plate 10 is locked by two U-shaped bolts 22 on a positioning rod 30 of a fixing seat (not shown). The above-mentioned ┌-shaped connecting unit 20 does not permit an up-and-down adjustment in axial direction (Y-direction). Moreover, the greatest drawback is that the U-shaped bolts 22 are not firmly fixed on the positioning rod 30. When the receiving dished plate 10 is subject to a wind force to create a large force-acting surface, the receiving dished plate 10 will be rotated to produce a huge inertia torque on the connecting unit 20. That is, the connecting element 20 produces a rotation in axial direction (Y-direction) at an angle of c. In this way, the receiving dished plate 10 is not aligned to a correct position for receiving the satellite signals, thereby resulting in a poor signal-receiving effect.

As shown in FIGS. 2A and 2B, another connecting unit 40 for a conventional receiving dished plate has an arched surface 41 at the internal side thereof. A clamping element 43 also has a corresponding arched surface 41 and is locked by screws 44 on the positioning rod 30. This structure permits an up-and-down adjustment of the positioning rod 30 in axial direction (Y-direction). However, this structure also has the problem of rotation on the Y-axle to form a deviation angle of ω.

As shown in FIGS. 3A and 3B, a further connecting unit 50 for a conventional receiving dished plate consists of a left and a right connecting element 51, 52 that are symmetrically arranged. The connecting elements 51, 52 are fixed by a screw 53 on the positioning rod 30. However, a contact surface 31 between the connecting elements 51, 52 is not able to be properly secured such that the connecting unit 50 may also be rotated on the positioning rod 30 to form a deviation angle of ω.

The above-mentioned connecting units 20, 40, 50 seem to be insignificant components. However, they are not fixed or welded on the positioning rod 30 before leaving the factory. They cannot be fixed on the positioning rod 30 until the receiving dished plate 10 is aligned to a correct receiving position at the assembly site. This insignificant component may, however, considerably affect the entire receiving quality. No matter how excellent equipment is employed, a poor receiving problem will still take place when the connecting unit is easily subject to wind effect and then loosened to form a deviation angle. As a result, this problem requires to be overcome.

### SUMMARY OF THE INVENTION

An object of the invention is to provide a retaining ring structure for fixing a satellite antenna that includes a retaining ring integrally formed by stamping a metal piece. A plurality of projecting pieces is formed at the internal side of the retaining ring for biting a positioning rod such that the retaining ring and the positioning rod are combined into one body when the positioning rod is firmly clamped by the retaining ring. The structure in accordance with the invention can withstand the inertia toque created by the strong wind force acting on the receiving dished plate. Meanwhile, the receiving dished plate won't be rotated so that an accurate direction of the receiving dished plate as well as an improved quality of receiving the satellite signals can be ensured.

In order to achieve the above-mentioned object, the invention includes:

a) a positioning rod adapted to support a receiving dished plate of a satellite antenna; and

b) a retaining ring mounted on the positioning rod, the front end of the retaining ring being attached to a back side of the receiving dished plate of a satellite antenna,

wherein the retaining ring is integrally formed by stamping a metal piece, and the retaining ring consists of a C-shaped body and two clamping pieces extending from a slot of the C-shaped body to the outside; and
wherein a plurality of projecting pieces is axially formed by a stamping process from the external side toward the internal side, and the projecting pieces are extended inwardly for a distance from 0.5 mm to 3 mm such that the C-shaped body is properly contracted to grip the positioning rod when the clamping pieces are tightened with bolts; meanwhile, the projecting pieces create a biting structure that bites the positioning rod such that the positioning rod is firmly held by the retaining ring to prevent the retaining ring from rotation on the positioning rod.

Based on the above-mentioned configuration, the projecting pieces on the internal wall of the retaining ring are formed as pimples. Alternatively, the projecting pieces are formed in protruding teeth arranged in axial direction. In this way, the projecting pieces bite the positioning rod in place when the retaining ring is tightened, thereby creating a stable connection structure.

### BRIEF DESCRIPTION OF THE DRAWINGS

The accomplishment of this and other objects of the invention will become apparent from the following descriptions and its accompanying figures of which:

FIGS. 1A and 1B are schematic drawings of a conventional connecting unit for a receiving dished plate of a satellite antenna;

FIGS. 2A and 2B are schematic drawings of another conventional connecting unit for a receiving dished plate of a satellite antenna;

FIGS. 3A and 3B are schematic drawings of a further conventional connecting unit for a receiving dished plate of a satellite antenna;

FIG. 4A is an exploded perspective view of a first embodiment of the invention;

FIG. 4B is a perspective assembly view of the first embodiment of the invention;

FIG. 4C is a cutaway view of the first embodiment of the invention;

FIG. 4D is a cutaway view of another structure of the first embodiment of the invention;

FIG. 5 is an exploded perspective view of a second embodiment of the invention;

FIG. 6A is a perspective assembly view of a third embodiment of the invention;

FIG. 6B is a cutaway view taken along line 6B-6B of FIG. 6A;

FIG. 7 is a perspective assembly view of a fourth embodiment of the invention;

FIG. 8A is a perspective assembly view of a fifth embodiment of the invention;

FIG. 8B is a cutaway view taken along line 8B-8B of FIG. 8A; and

FIG. 9 is a schematic drawing of the invention in application state.

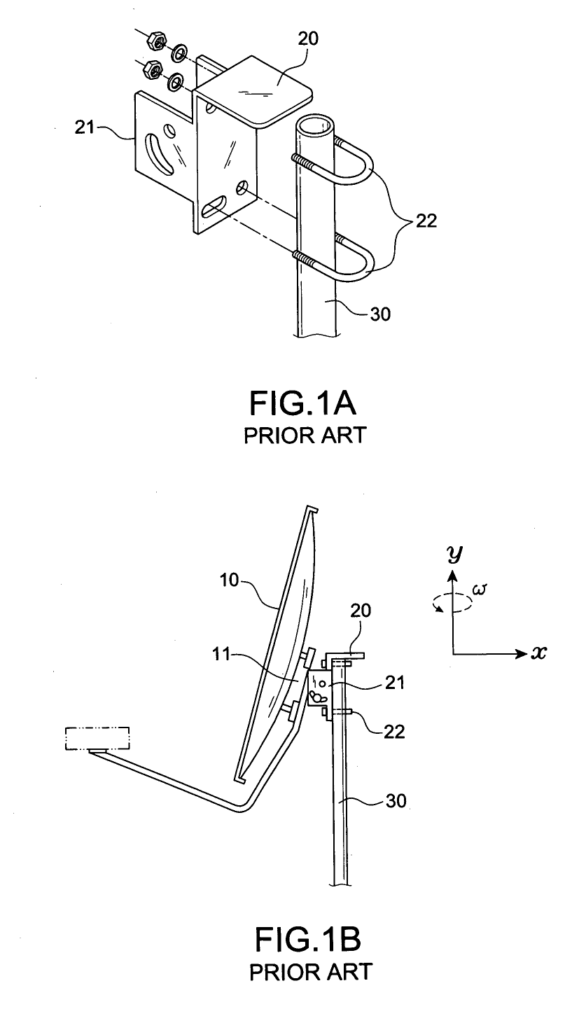

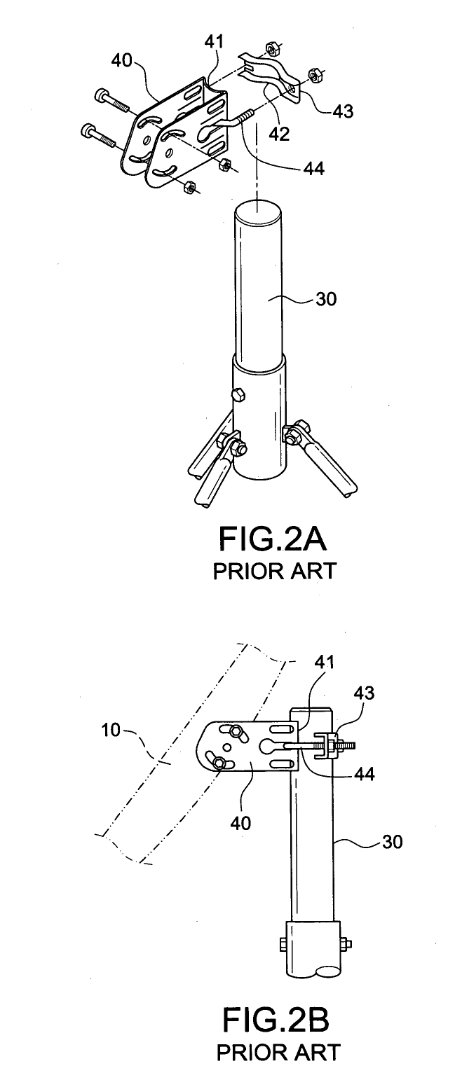

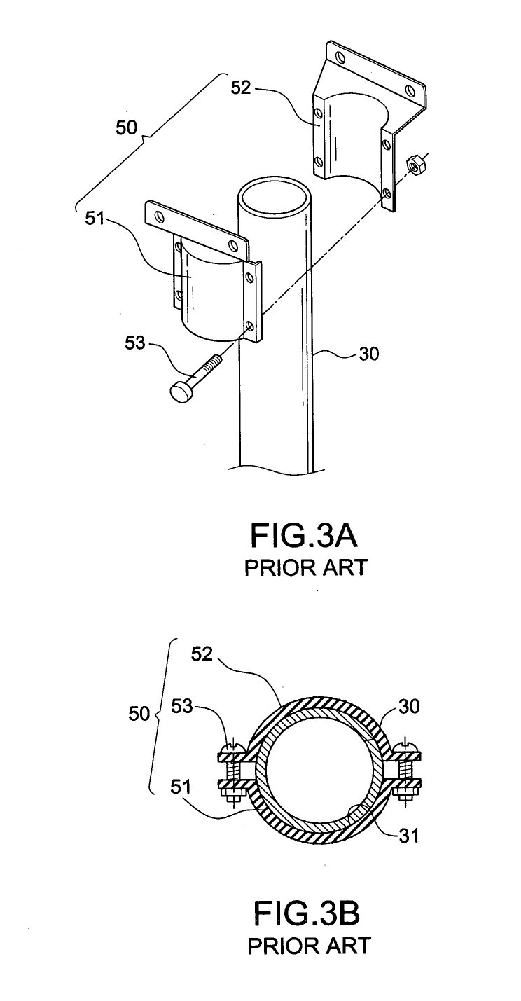

### DETAILED DESCRIPTION OF THE PREFERRED EMBODIMENT

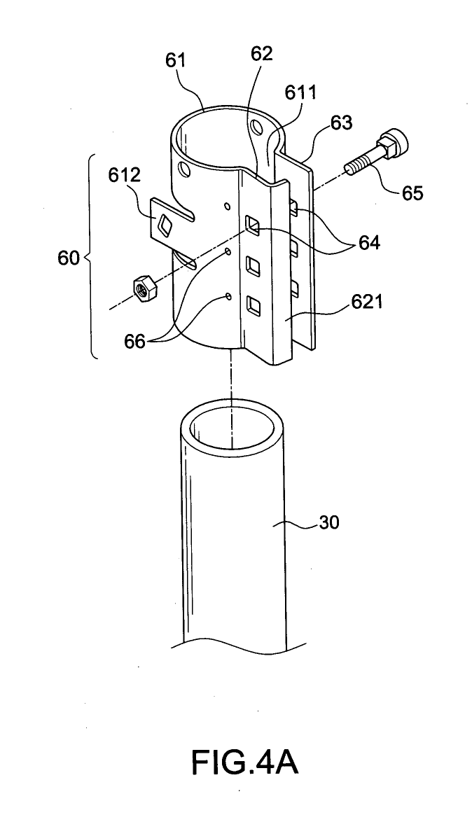

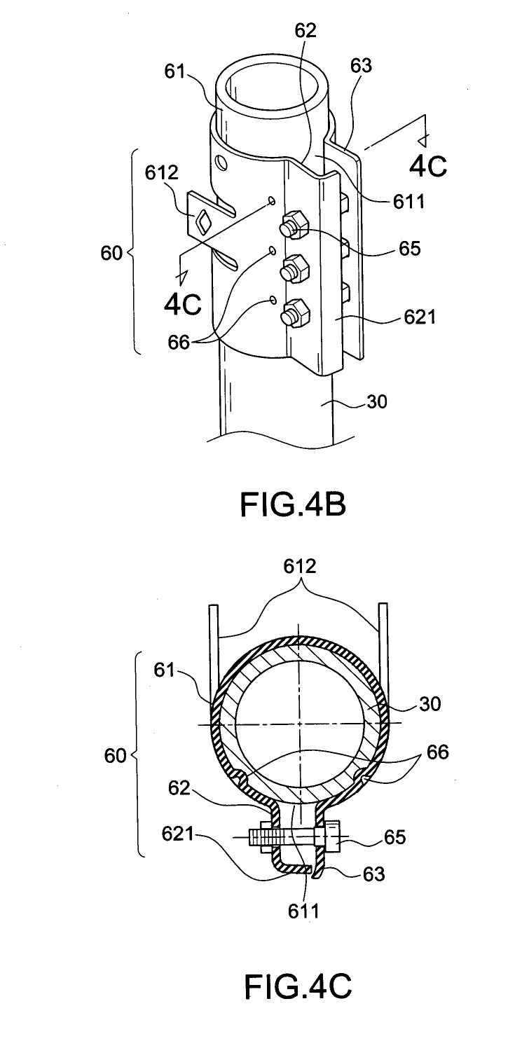

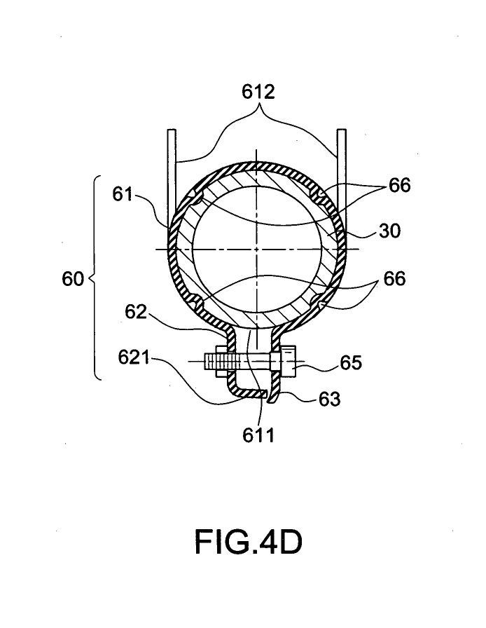

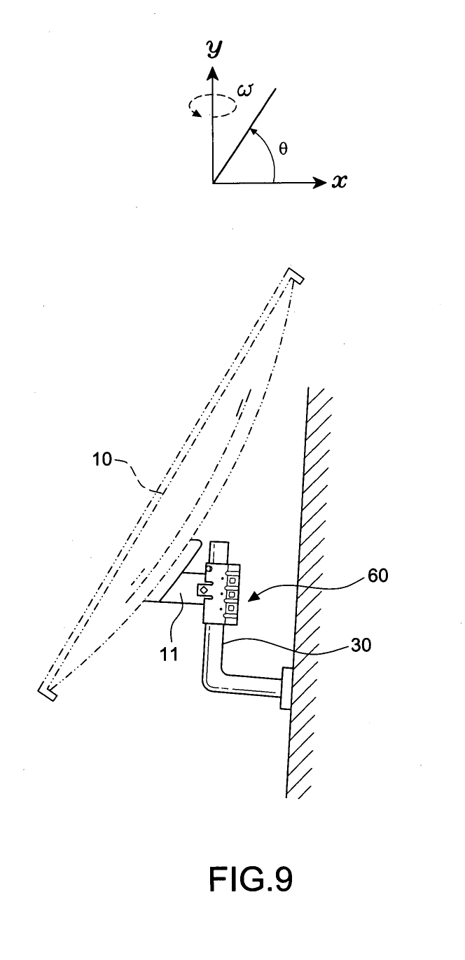

First of all, referring to FIGS. 4A through 4D, a first embodiment of the invention includes a positioning rod 30 and a retaining ring 60. The positioning rod 30 is adapted to support a receiving dished plate 10 of a satellite antenna (see FIG. 9). The positioning rod 30 is fixed either on a wall or on a base. The positioning rod 30 is necessary for the products of the invention. However, it is not the primary feature of the invention so that no further descriptions are given hereinafter. The retaining ring 60 is mounted on the positioning rod 30. The front end of the retaining ring 60 is attached to a back side 11 of the receiving dished plate 10 of a satellite antenna. In other words, the retaining ring 60 serves as a connecting element of the receiving dished plate 10.

In order to eliminate the drawbacks of the conventional connecting element that easily causes rotation, the invention is characterized in that the retaining ring 60 is integrally formed by stamping a metal piece. That is, the retaining ring 60 in accordance with the invention is integrally formed rather than formed by two elements assembled later to be the connecting element. As a result, the retaining ring 60 consists of a C-shaped body 61 and two clamping pieces 62, 63 extending from a slot 611 of the C-shaped body 61 to the outside. The clamping pieces 62, 63 each include a plurality of the connection holes 64 for several bolts 65. The clamping pieces 62, 63 approach to each other in tightening the bolts 65, thereby contracting the slot 611 of the C-shaped body 61 to clamp the positioning rod 30. The C-shaped body 61 includes two protruding ears 612 formed in a stamping process and extending forward. The protruding ears 612 are adapted to fix the receiving dished plate 10 and formed in a proper position. No further descriptions thereto are given hereinafter.

The above-mentioned structure is still not able to prevent the wind force from acting on the receiving dished plate 10, thereby producing a huge inertia torque. A plurality of projecting pieces 66 is axially formed by a stamping process from the external side toward the internal side. The projecting pieces 66 are extended inwardly preferably for a distance from 0.5 mm to 3 mm such that the C-shaped body 61 is properly contracted when the clamping pieces 62, 63 are tightened with the bolts 65. At that time, the projecting pieces 66 bite the positioning rod 30 such that the positioning rod 30 is firmly held by the retaining ring 60, as shown in FIG. 4C. Due to the biting action, the retaining ring 60 can be prevented from rotation when the receiving dished plate 10 is subject to an inertia torque. In this way, an accurate receiving direction is ensured and unmovable.

According to the above-mentioned embodiment, the projecting pieces 66 are formed as pimples axially arranged to create gripping teeth for biting the positioning rod 30. The number of the rows of the projecting pieces 66 may depend on different requirements. According to the embodiment of the FIGS. 4A through 4C, two rows of the axial projecting pieces 66 are disposed near the slot 611 of the C-shaped body 61. However, it should not be restricted thereto. As shown in FIG. 4D, four rows of the axial projecting pieces 66 can be provided. No further descriptions thereto are given hereinafter.

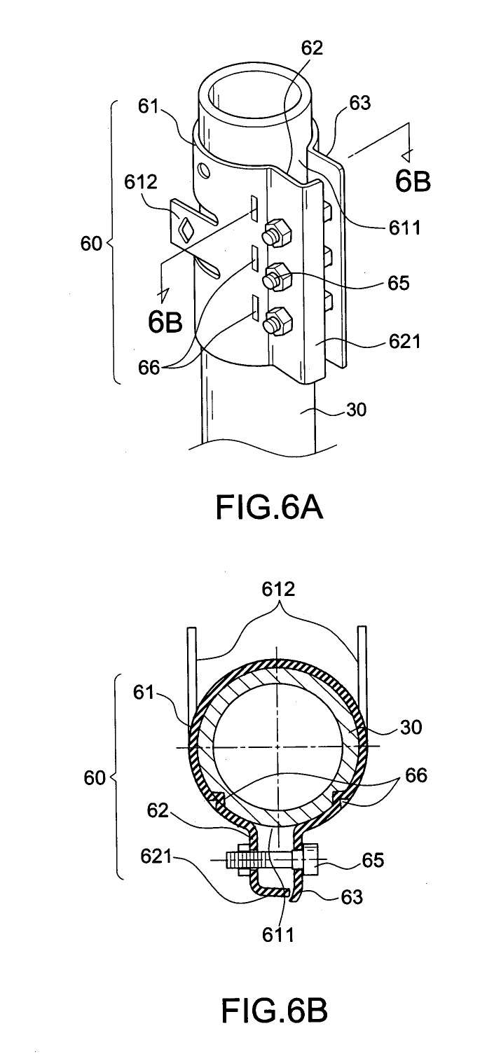

According to a third embodiment in FIGS. 6A and 6B, the projecting pieces 66 are formed in several rows of protruding teeth in axial direction (Y-direction) for linearly biting the positioning rod 30. It is proven by tests that both types of the above-mentioned projecting pieces 66 can be integrally formed by the stamping process on the C-shaped body 61 for firmly biting the positioning rod 30 in place.

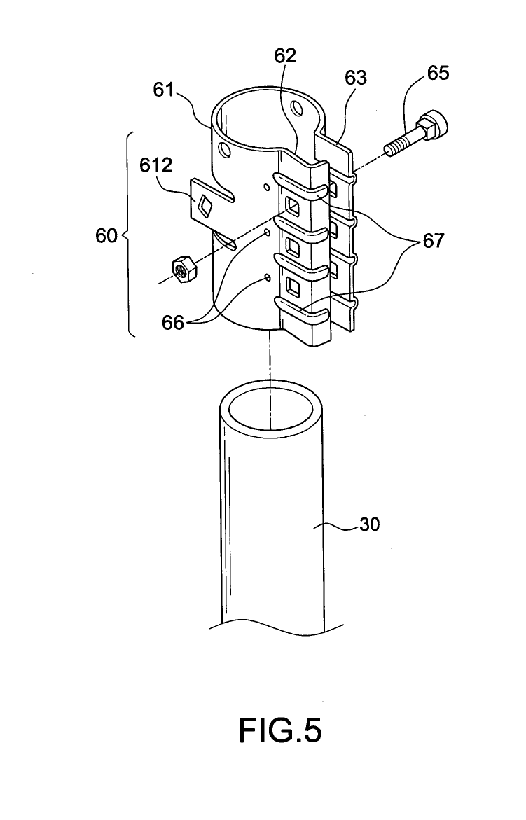

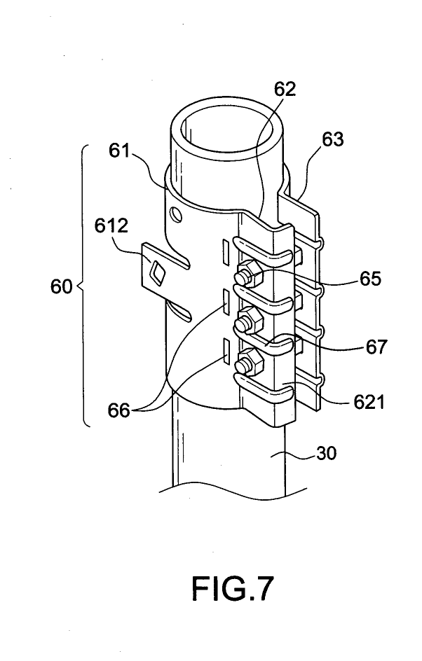

According to the second and the fourth embodiment of the invention shown in FIGS. 5 and 7, a plurality of protruding ribs 67 is horizontally arranged on the surface of the clamping pieces 62, 63 for enhancing the mechanical strength of the retaining ring 60. Furthermore, one end of the clamping piece 62 is bent inwardly in a vertical state toward the clamping piece 63 to form a restriction side 621 for keeping a proper clamping gap. Meanwhile, the restriction side 621 prevents the clamping pieces 62, 63 from over-tightening that causes an undesirable deformation.

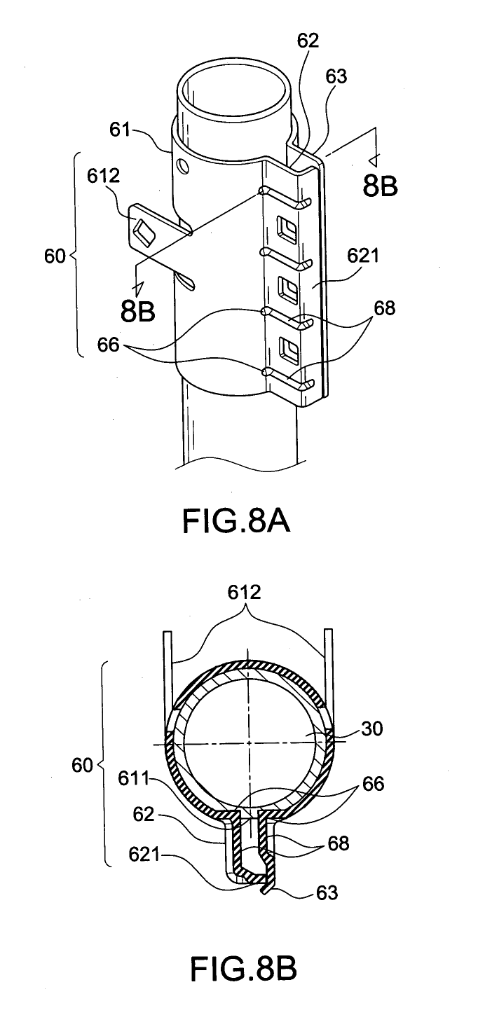

FIGS. 8A and 8B show a perspective view and a cutaway view of a fifth embodiment of the invention. The elements identical to the above-mentioned embodiments are marked with the same reference signs. The difference lies in that a plurality of grooved ribs 68 is horizontally arranged on the surface of the clamping pieces 62, 63. The grooved ribs 68 are formed in opposite direction relative to the above-mentioned protruding ribs 67. The grooved ribs 68 are extended to the internal side of the C-shaped body 61 in such a way that two rows of ̂-shaped projecting pieces 66 are axially formed for biting the positioning rod 30 in place. As previously stated, the projecting pieces 66 guarantee a firm connection of the retaining ring 60 on the positioning rod 30.

Based on the above-mentioned configuration, the retaining ring 60 may be firmly secured on the positioning rod 30 into a body after the retaining ring 60 is tightened. As shown in FIG. 9, the structure in accordance with the invention may withstand the inertia torque produced by the strong wind force acting on the receiving dished plate 10 without creating a rotation in an angle of ω, thereby ensuring an accurate direction of the receiving dished plate 10 as well as an improved quality of receiving the satellite signals. Moreover, the integrally formed retaining ring 60 is easy for assembly. In addition, the receiving dished plate 10 is movable on the positioning rod 30 for a practical adjustment of height and inclination (θ) without affecting a normal operation.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A retaining ring structure for fixing a satellite antenna, comprising:
a) a positioning rod adapted to support a receiving dished plate of a satellite antenna; and
b) a retaining ring mounted on the positioning rod, the front end of the retaining ring being attached to a back side of the receiving dished plate of a satellite antenna,
wherein the retaining ring is integrally formed by stamping a metal piece, and the retaining ring consists of a C-shaped body and two clamping pieces extending from a slot of the C-shaped body to the outside; and
wherein a plurality of projecting pieces is axially formed by a stamping process from the external side toward the internal side, and the projecting pieces are extended inwardly for a distance from 0.5 mm to 3 mm such that the C-shaped body is properly contracted to grip the positioning rod when the clamping pieces are tightened with bolts; meanwhile, the projecting pieces create a biting structure that bites the positioning rod such that the positioning rod is firmly held by the retaining ring to prevent the retaining ring from rotation on the positioning rod.

2. The retaining ring structure for fixing a satellite antenna as recited in claim 1 wherein the projecting pieces on the internal wall of the retaining ring are formed as pimples.

3. The retaining ring structure for fixing a satellite antenna as recited in claim 1 wherein the projecting pieces are formed in protruding teeth arranged in axial direction.

4. The retaining ring structure for fixing a satellite antenna as recited in claim 1 wherein the C-shaped body includes two protruding ears formed in a stamping process and extending forward.

5. The retaining ring structure for fixing a satellite antenna as recited in claim 1 wherein the clamping pieces each include a plurality of the connection holes for the bolts.

6. The retaining ring structure for fixing a satellite antenna as recited in claim 1 wherein a plurality of protruding ribs is horizontally arranged on the surface of the clamping pieces, and one end of the clamping piece 62 is bent inwardly in a vertical state toward the other clamping piece to form a restriction side for keeping a proper clamping gap.

7. The retaining ring structure for fixing a satellite antenna as recited in claim 1 wherein a plurality of grooved ribs is horizontally arranged on the surface of the clamping pieces, and the grooved ribs are extended to the internal side of the C-shaped body 61 in such a way that two rows of ̂-shaped projecting pieces 66 are axially formed for biting the positioning rod 30 in place.
